(19) United States
(12) Patent Application Publication
(10) Pub. No.: US 2014/0292489 A1
(43) Pub. Date: Oct. 2, 2014

(54) POSITIONING SYSTEM AND POSITIONING METHOD

(71) Applicant: Wistron NeWeb Corp., Hsinchu (TW)

(72) Inventors: Yen Chun PENG, Hsinchu (TW); Yen-Liang WU, Hsinchu (TW); Kuo-Ping LIN, Hsinchu (TW)

(73) Assignee: Wistron NeWeb Corp., Hsinchu (TW)

(21) Appl. No.: 13/954,701

(22) Filed: Jul. 30, 2013

(30) Foreign Application Priority Data
Mar. 27, 2013 (TW) 102110817

(51) Int. Cl. G06K 7/00

(52) U.S. Cl. CPC G06K 7/0008
USPC 340/10.1

(57) ABSTRACT

A positioning system includes an object storage device, a plurality of RFID (Radio Frequency Identification) tags, an antenna, and an RFID reader. The object storage device includes a plurality of storage vacancies. The RFID tags are respectively disposed in the storage vacancies. The antenna is disposed in the object storage device. The RFID reader detects the RFID tags via the antenna. The RFID reader stores a corresponding relationship between the RFID tags and the storage vacancies. When an object is placed in a specific storage vacancy, the RFID reader determines that a specific RFID tag disposed in the specific storage vacancy is no longer detectable, and determines that the specific storage vacancy is occupied further according to the corresponding relationship.

### CROSS REFERENCE TO RELATED APPLICATIONS

This Application claims priority of Taiwan Patent Application No. 102110817 filed on Mar. 27, 2013, the entirety of which is incorporated b reference herein.

### BACKGROUND OF THE INVENTION

1. Field of the Invention

The disclosure generally relates to a positioning system, and more particularly, relates to a positioning system using RFID (Radio Frequency Identification) technology.

2. Description of the Related Art

In prior art, methods for positioning objects via an RFID (Radio Frequency

Identification) system include: (1) space path marking methods, (2) triangle localization algorithms, and (3) regional localization methods. The foregoing methods involve establishing relative positions in advance, and using a. specific algorithm to calculate reflected signal strengths from RFID tags. Following, a cross-analysis is performed according to the result, and a position of an object under test is estimated. However, the drawbacks of the prior art methods are high deviation and low accuracy for determining object positions. Thus, it is difficult to inventory objects by using a conventional RFID system. If more information about relative positions of the inventoried objects is required, the total cost thereof will be much higher than the expense for establishing the RFID system.

### BRIEF SUMMARY OF THE INVENTION

In one exemplary embodiment, the disclosure is directed to a positioning system, comprising: an object storage device, comprising a plurality of storage vacancies: a plurality of RFID (Radio Frequency Identification) tags, respectively disposed in the storage vacancies: an antenna, disposed in the object storage device; and an RFID reader, coupled to the antenna, and detecting the RFID tags via the antenna, wherein the RFID reader stores a corresponding relationship between the RFID tags and the storage vacancies; wherein when a first object is placed in a first storage vacancy, the RFID reader determines that a first RFID tag disposed in the first storage vacancy is no longer detectable, and the RFID reader determines that the first storage vacancy is occupied further according to the corresponding, relationship.

In another exemplary embodiment, the disclosure is directed to a positioning method, comprising the steps of providing an object storage device comprising a plurality of storage vacancies, wherein a plurality of RFID (Radio Frequency Identification) tags are respectively disposed in the storage vacancies; detecting the RFID tags by an RFID reader and at least an antenna; determining that a first RFID tag disposed in a first storage vacancy is no longer detectable by the RFID reader and the antenna; and determining that the first storage vacancy is occupied according to a detection result of the RFID reader and according to a corresponding relationship between the RFID tags and the storage vacancies.

### BRIEF DESCRIPTION OF DRAWINGS

The invention can be more fully understood by reading the subsequent detailed description and examples with references made to the accompanying drawings, wherein:

FIG. 1 is a diagram for illustrating a positioning system according to an embodiment of the invention;

FIG. 2 is a diagram for illustrating a positioning system according to an embodiment of the invention;

FIG. 3 is a diagram for illustrating a positioning system according to an embodiment of the invention;

FIG. 4 is a diagram for illustrating a positioning system according to an embodiment of the invention;

FIG. 5 is a diagram for illustrating a positioning system according to an embodiment of the invention;

FIG. 6 is a diagram for illustrating a positioning system according to an embodiment of the invention;

FIG. 7 is a diagram for illustrating a positioning system according to an embodiment of the invention; and

FIG. 8 is a flowchart for illustrating a positioning method according to an embodiment of the invention.

### DETAILED DESCRIPTION OF THE INVENTION

In order to illustrate the purposes, features and advantages of the invention, the embodiments and figures thereof in the invention are shown in detail as follows.

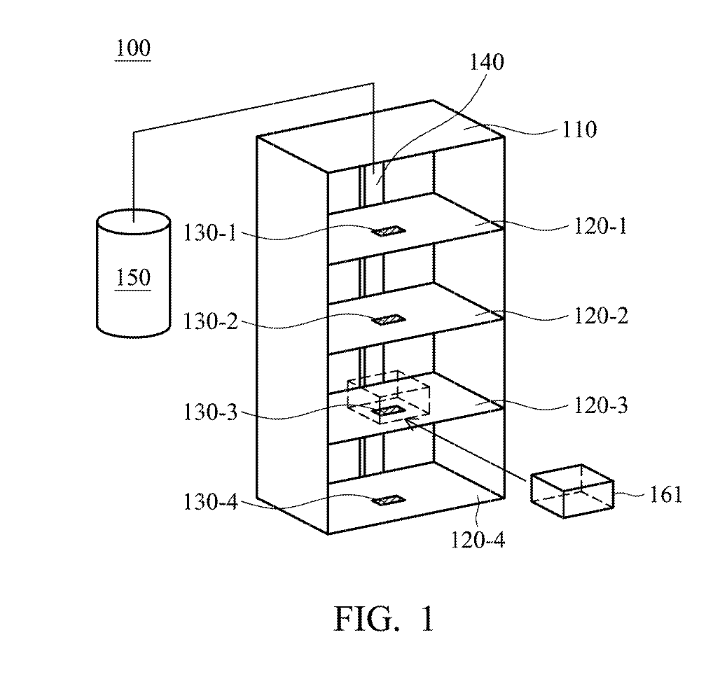

FIG. 1 is a diagram for illustrating a positioning system 100 according to an embodiment of the invention. As shown in FIG. 1, the positioning system 100 comprises an object storage device 110, a plurality of RFID (Radio Frequency Identification) tags 130-1, 130-2, 130-3, and 130-4, at least one antenna 140, and an RFID reader 150. The object storage device 110 comprises a plurality of storage vacancies 120-1, 120-2, 120-3, and 120-4. The style of the object storage device of FIG. 1 is an exemplary. For example, the object storage device 110 may be a cabinet or a shelf. The type, shape size, material and color of the object storage device 110 are not limited in the invention. The RFID tags 130-1, 130-2, 130-3, and 130-4 are respectively disposed in the storage vacancies 120-1, 120-2. 120-3, and 120-4. It should be understood that although FIG. 1 shows only four RFID tags disposed in four storage vacancies, the positioning system of the invention may comprise less or more storage vacancies and RFID tags. Generally, the RFID tags 130-1, 130-2, 130-3, and 130-4 are configured to mark the storage vacancies 120-1, 120-2, 120-3, and 120-4, and the RFID reader 150 or a processor coupled thereto (not shown) is capable of identifying the storage vacancies 120-1, 120-2, 120-3, and 120-4 according to the RFID tags 130-1 130-2, 130-3, and 130-4. According to an embodiment of the invention, the object storage device 110 can be made of metal, and the RFID tags 130-1, 130-2, 130-3, and 130-4 can be anti-metal RFID tags.

The antenna 140 is disposed in the object storage device 110, and the object storage device 110 is within the radiation region of the antenna 140. The type of the antenna 140 is not limited in the invention. For example, the antenna 140 may be a monopole antenna, a dipole antenna, a loop antenna, a patch antenna, a PIFA (Planar Inverted F Antenna), or a chip antenna, etc. hi sonic embodiments, the antenna 140 operates in a UHF (Ultra High Frequency) band, which is approximately from 860 MHz to 960 MHz. In other embodiments, the positioning system 100 may further comprise two, three, four, or more antennas 140, which are adjustable in response to the antenna radiation region required by the whole system. The RFID reader 150 is coupled to the antenna 140, and detects the RFID tags 130-1, 130-2, 130-3, and 130-4 via the antenna 140. In some embodiments, the RFID reader 150 or a memory device coupled thereto (not shown) stores a corresponding relationship between the RFID tags 130-1, 130-2, 130-3, and 130-4 and the storage vacancies 120-1, 120-2, 120-3, and 120-4 in advance. For example, the corresponding relationship comprises the information that the RFID tag 130-1 is disposed in the storage vacancy 120-1, the RFID tag 130-2 is disposed in the storage vacancy 120-2, the RFID tag 130-3 is disposed in the storage vacancy 120-3, and so on.

According to an embodiment of the invention, the positioning system 100 can position any object as follows. For example, when an object 161 is placed in a storage vacancy 120-3 of the object storage device 110, the RFID reader 150 determines that an RFID tag 130-3 disposed in the storage vacancy 120-3 is no longer detectable because the RFID tag 130-3 may be shielded by the object 161. In some embodiments, the object 161 is conductive a server with a metal housing), and when the object 161 is placed in the storage vacancy 120-3, the RFID tag 130-3 is covered by the object 161 and is no longer detectable. Accordingly, the RFID reader 150 or a processor coupled thereto (not shown) determines that the storage vacancy 120-3 is occupied according to the detection result and according to the corresponding relationship between the RFID tags and the storage vacancies. In other embodiments, the object 161 may be placed in any other storage vacancy of the object storage device 110, and the positioning system 100 can perform a positioning procedure in similar ways. In some embodiments, the positioning system 100 further comprises an output device (riot shown), such as an LCD (Liquid Crystal Display), a computer display, a mobile phone display, or a printer. The output device is configured to output a determination result of the RFID reader 150 or the processor. An operator managing the positioning system 100 can read the determination result and accordingly manage the storage vacancies 120-1, 120-2, 120-3, and 120-4 of the object storage device 110. In some embodiments, the positioning system 100 further comprises a relative management device (not shown) configured to obtain the determination result and perform a management procedure.

According to various embodiments of the invention, the positioning system disposes a plurality of RFID tags in a plurality of storage vacancies of an object storage device in advance, and determines which storage vacancy an object is located in according to a shielded RFID tag (or an undetectable RFID tag). An operator or other relative equipments call manage the plurality of storage vacancies of the object storage device according to the determination result. Accordingly, the labor cost for managing the object storage device is reduced. Since the positioning system performs a positioning procedure on the object by comparing the shielded RFID tag with the plurality of storage vacancies, the positioning error can be less than 10 cm. In addition, the positioning system according to another embodiment of the invention can be implemented with simple circuits. In comparison to conventional designs, the invention has the advantages of low cost, low complexity, and low error rate, and is suitably applied to a variety of logistics management systems and item inventory systems.

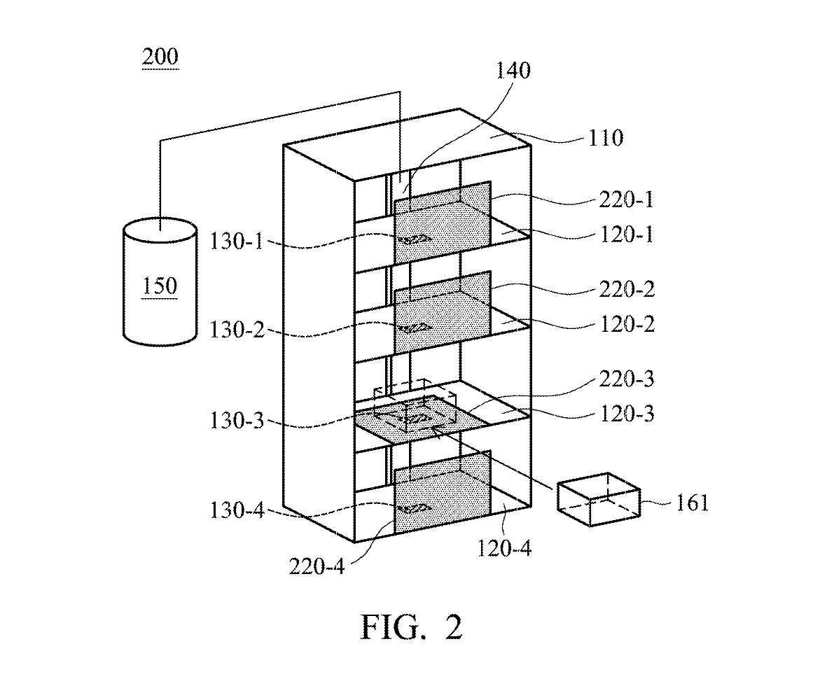

FIG. 2 is a diagram for illustrating a positioning system 200 according to an embodiment of the invention. FIG. 2 is similar to FIG. 1. In the embodiment, the object 161 is nonconductive. To avoid that the nonconductive object 161 does not shield the RFID tags 130-1, 130-2, 130-3, and 130-4 well, the object storage device 110 further comprises a plurality of shield elements 220-1, 220-2, 220-3, and 220-4. The types, shapes, and sizes of the shield elements 220-1, 220-2, 220-3, and 220-4 are not limited in the invention. In some embodiments, the shield elements 220-1, 220-2, 220-3, and 220-4 are made of metal. In some embodiments, the shield elements 220-1, 220-2, 220-3, and 220-4 are movable metal covers configured to selectively cover the RFID tags 130-1, 130-2, 130-3, and 130-4. For example, when the object 161 is placed in the storage vacancy 120-3, the RFID tag 130-3 is covered by the shield element 220-3, and the RFID reader 150 determines that the RFID tag 130-3 is no longer detectable. As a result, the object 161 can be positioned precisely. Other features of the positioning system 200 of FIG. 2 are similar to those of the positioning system 100 of FIG. 1. Accordingly, the two embodiments can achieve similar performances.

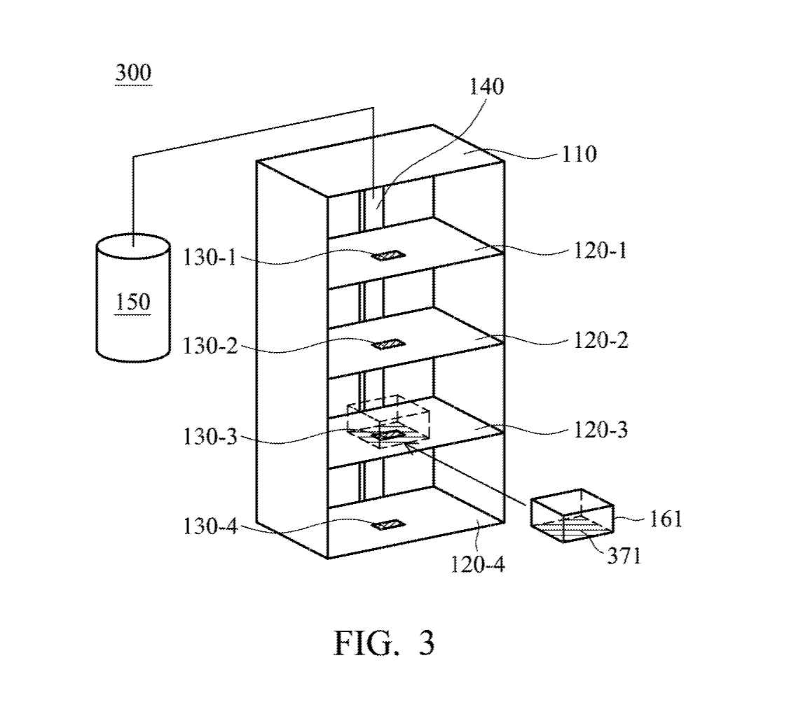

FIG. 3 is a diagram for illustrating a positioning system 300 according to an embodiment of the invention. FIG. 3 is similar to FIG. 1. In the embodiment, the object 161 is nonconductive. To avoid that the nonconductive object 161 does not shield the RFID tags 130-1, 130-2, 130-3, and 130-4 well, a surface (e.g., a lower surface) of the object 161 is covered by a conductive material 371 or an electromagnetic-wave absorbing material 371. In some embodiments, the conductive material 371 or the electromagnetic-wave absorbing material 371 may be a metal plate, a piece of aluminum foil paper, a magnetic material, or a carbon fiber material. For example, when the object 161 is placed in the storage vacancy 120-3, the RFID tag 130-3 is covered by the conductive material 371 or the electromagnetic-wave absorbing material 371, and the RFID reader 150 determines that storage vacancy 120-3 is occupied. As a result, the object 161 can be positioned precisely. Other features of the positioning system 300 of FIG. 3 are similar to those of the positioning system 100 of FIG. 1. Accordingly, the two embodiments can achieve similar performances.

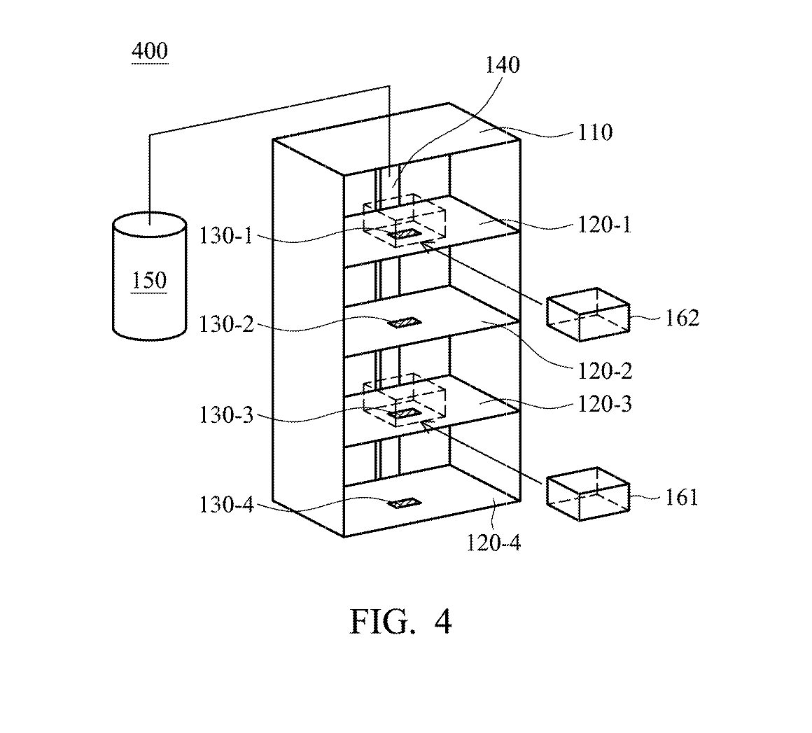

FIG. 4 is a diagram for illustrating a positioning system 400 according to an embodiment of the invention. FIG. 4 is similar to FIG. 1. In the embodiment, the positioning system 400 performs a positioning procedure on a plurality of objects. For example, in addition to the object 161, when another object 162 is placed in the storage vacancy 120-1, the RFID reader 150 determines that the RFID tag 130-1 disposed in the storage vacancy 120-1 is no longer detectable. Accordingly, the RFID reader 150 or a processor (not shown) coupled thereto determines that the storage vacancy 120-1 is occupied according to the detection result and according to the corresponding relationship between the RFID tags and the storage vacancies. In other embodiments, the positioning system 400 further performs the positioning procedure on three, four, five, or more objects which occupy some storage vacancies of the object storage device. Other features of the positioning system 400 of FIG. 4 are similar to those of the positioning system 100 of FIG. 1. Accordingly, the two embodiments can achieve similar performances.

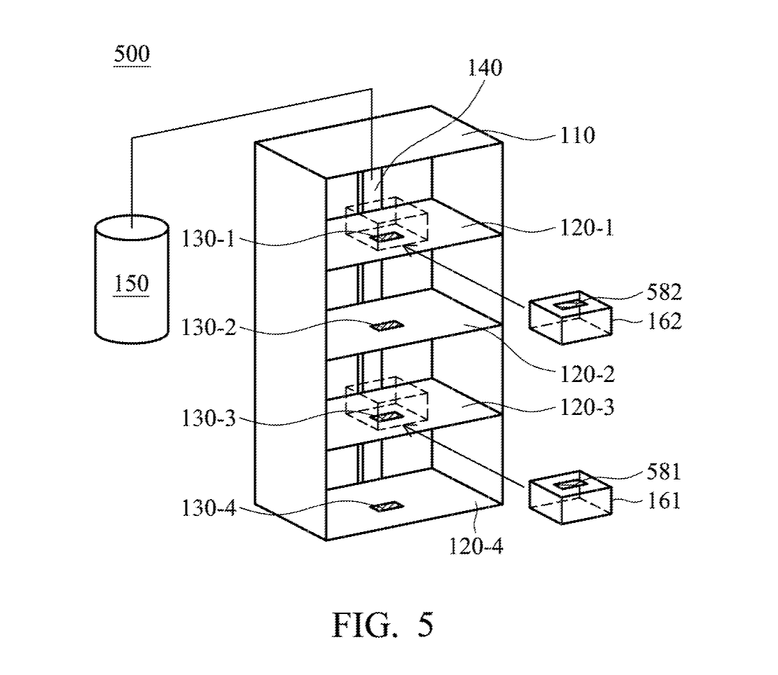

FIG. 5 is a diagram for illustrating a positioning system 500 according to an embodiment of the invention. FIG. 5 is similar to FIG. 1. In the embodiment, an object RFID tag 581 is affixed to the object 161, and another object RFID tag 582 is affixed to the object 162. The RFID reader 150 detects the object RFID tag 581 via the antenna 140 to identify the object 161, and detects the object RFID tag 582 via the antenna 140 to identify the object 162. In the embodiment, one or more objects having different object RFID tags are placed in the object storage device 110 independently, and the RFID reader 150 or a processor (not shown) coupled thereto determines the positions of the objects according to the object RFID tags and according to one or more undetectable RFID tags in a plurality of storage vacancies. For example, when the object 161 is placed in the storage vacancy 120-3, the RFID reader 150 determines that the RFID tag 130-3 disposed in the storage vacancy 120-3 is no longer detectable and that an additional object RFID tag 581 is in the detection region. Accordingly, the RFID reader 150 or the processor coupled thereto determines that the storage vacancy 120-3 is occupied by the object 161 having the object RFID tag 581 according to the detection result and according to the corresponding relationship between the RFID tags and the storage vacancies. The positioning system 500 can detect all of the objects placed into the storage vacancies one after another in similar ways. Other features of the positioning system 500 of

FIG. 5 are similar to those of the positioning system 100 of FIG. 1. Accordingly, the two embodiments can achieve similar performances.

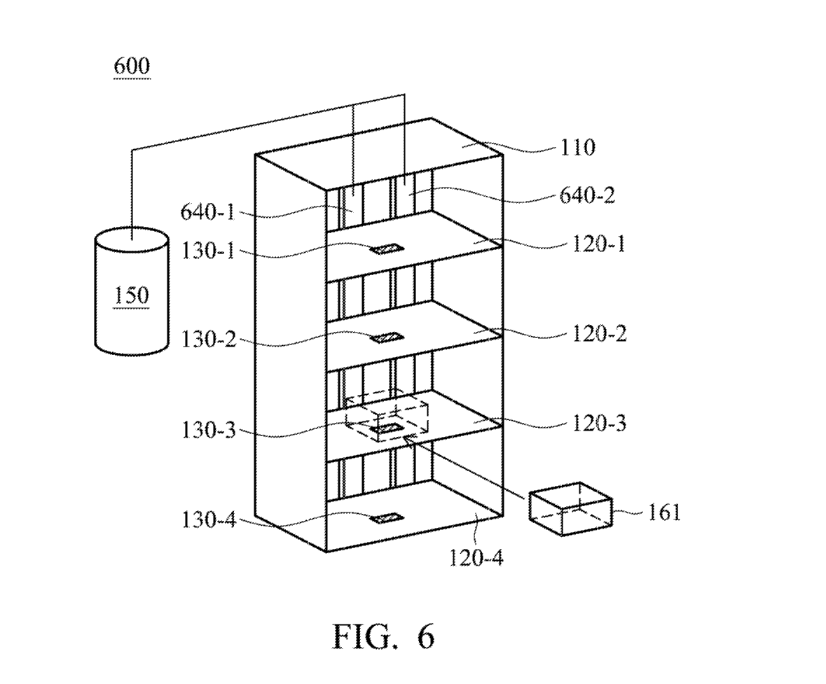

FIG. 6 is a diagram for illustrating a positioning system 600 according to an embodiment of the invention. FIG. 6 is similar FIG. 1. In the embodiment, the positioning system 600 comprises at least two cylindrical antennas 640-1 and 640-2, Which are both coupled to the RFID reader 150. The antennas 640-1 and 640-2 may be respectively disposed adjacent to different sides of the object storage device 110. By communications via the antennas 640-1 and 640-2, the RFID reader 150 can detect all of the RFID tags in the object storage device 110 without blind spots. Other features of the positioning system 600 of FIG. 6 are similar to those of the positioning system 100 of FIG. 1. Accordingly, the two embodiments can achieve similar performances.

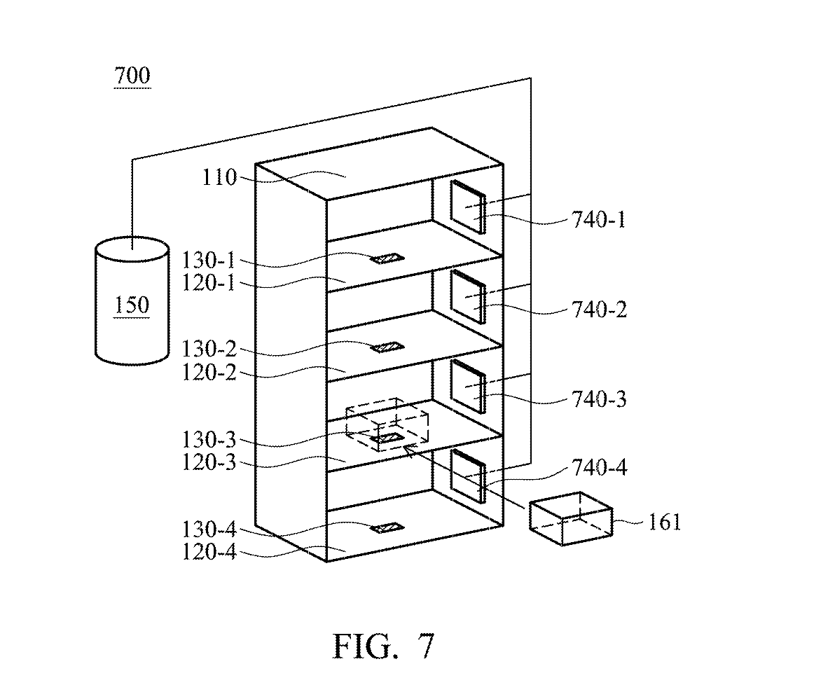

FIG. 7 is a diagram for illustrating a positioning system 700 according to an embodiment of the invention. FIG. 7 is similar to FIG. 1. In the embodiment, the positioning system 700 comprises a plurality of patch antennas 740-1. 740-2, 740-3, and 740-4, which are all coupled to the reader 150. The patch antennas 740-1, 740-2, 740-3, and 740-4 may be respectively disposed in the storage vacancies 120-1, 120-2, 120-3, and 120-4. Since the patch antenna has a narrow radiation pattern, each storage vacancy comprises a patch antenna to improve the detection accuracy in the positioning system 700. In the other embodiments, there is less or more patch antennas disposed in the object storage device 110 in response to the number of the storage vacancies thereof. Other features of the positioning system 700 of FIG. 7 are similar to those of the positioning system 100 of FIG. 1. Accordingly, the two embodiments can achieve similar performances.

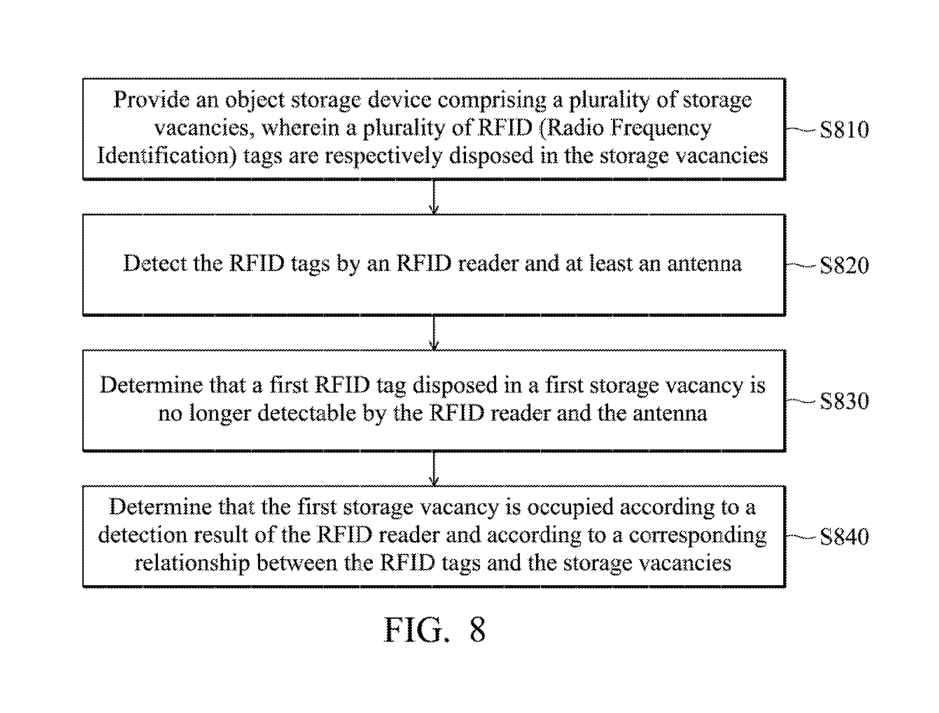

FIG. 8 is a flowchart for illustrating a positioning method according to an embodiment of the invention. To begin, in step S810, an object storage device comprising a plurality of storage vacancies is provided, wherein a plurality of RFID (Radio Frequency Identification) tags are respectively disposed in the storage vacancies. In step S820, the RFID tags are detected by an RFID reader and at least an antenna. In step S830, it is determined by the RFID reader and the antenna that a first RFID tag disposed in a first storage vacancy is no longer detectable. Finally, in step S840, it is determined that the first storage vacancy is occupied according to a detection result of the RFID reader and according to a corresponding relationship between the RFID tags and the storage vacancies. The determination of the step S840 may be performed by the RFID reader or a processor coupled thereto.

In some embodiments. a first object RFID tag is affixed to a first object, and the positioning method further comprises: detecting the first object RFID tag to identify the first object by the RFID reader and the antenna. In some embodiments, the positioning method further comprises: determining that a second RFID tag disposed in a second storage vacancy is no longer detectable by the RFID reader and the antenna, and determining that the second storage vacancy is occupied according to the detection result of the RFID reader and according to the corresponding relationship between the RFID tags and the storage vacancies. In sonic embodiments, a second object RFID tag is affixed to a second object, and the positioning method further comprises: detecting the second object RFID tag to identify the second object by the RFID reader and the antenna. Note that every detailed feature of the embodiments of FIGS. 1-7 may be applied to the positioning method of FIG. 8.

The method according to various embodiments of the invention, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A positioning system, comprising:
an object storage device, comprising a plurality of storage vacancies;
a plurality of RFID (Radio Frequency Identification) tags, respectively disposed in the storage vacancies;
an antenna, disposed in the object storage device; and
an RFID reader, coupled to the antenna, and detecting the RFID tags via the antenna, wherein the RFID reader stores a corresponding relationship between the RFID tags and the storage vacancies;
wherein when a first object is placed in a first storage vacancy, the RFID reader determines that a first RFID tag disposed in the first storage vacancy is no longer detectable, and the RFID reader determines that the first storage vacancy is occupied further according to the corresponding relationship.

2. The positioning, system as claimed in claim 1, wherein the object storage device is made of metal.

3. The positioning system as claimed in claim 2, wherein the RFID tags are anti-metal RFID tags.

4. The positioning system as claimed in claim 1, wherein the first object is conductive, and when the first object is placed in the first storage vacancy, the first RFID tag is covered by the first object.

5. The positioning system as claimed in claim 1, wherein the first object is nonconductive, and the object storage device further comprises a plurality of shield elements, wherein when the first object is placed in the first storage vacancy, the first RFID tag is covered by a first shield element.

6. The positioning system as claimed in claim 1, wherein the first object is nonconductive, a surface of the first object is covered by a conductive material or an electromagnetic-wave absorbing material, wherein when the first object is placed in the first storage vacancy, the first RFID tag is covered by the conductive material or the electromagnetic-wave absorbing material.

7. The positioning system as claimed in claim 1, wherein the antenna operates in a UHF (Ultra High Frequency) band from 860 MHz to 960 MHz.

8. The positioning system as claimed in claim 1, wherein a first object RFID tag is affixed to the first object, and the RFID reader detects the first object RFID tag via the antenna to identify the first object.

9. The positioning system as claimed in claim 1, wherein when a second object is placed in a second storage vacancy, the rum reader determines that a second RFID tag disposed in the second storage vacancy is no longer detectable, and the RFID reader determines that the second storage vacancy is occupied further according to the corresponding relationship.

10. The positioning system as claimed in claim 9, wherein a second object RFID tag is affixed to the second object, and the RFID reader detects the second object RFID tag via the antenna to identify the second object.

11. A positioning method, comprising the steps of:
providing an object storage device comprising a plurality of storage vacancies, wherein a plurality of RFID (Radio Frequency Identification) tags are respectively disposed in the storage vacancies;
detecting the RFID tags by an RFID reader and at least an antenna;
determining that a first RFID tag disposed in a first storage vacancy is no longer detectable by the RFID reader and the antenna; and
determining that the first storage vacancy is occupied according to a detection result of the RFID reader and according to a corresponding relationship between the RFID tags and the storage vacancies.

12. The positioning method as claimed in claim 11, wherein the object storage device is made of metal.

13. The positioning method as claimed in claim 12, wherein the RFID tags are anti-metal RFID tags.

14. The positioning method as claimed in claim 11, wherein a first object is conductive, and when the first object is placed in the first storage vacancy, the first RFID tag is covered by the first object.

15. The positioning method as claimed in claim 11 wherein a first object is nonconductive, a surface of the first object is covered by a conductive material or an electromagnetic-wave absorbing material, wherein when the first object is placed in the first storage vacancy, the first RFID tag is covered by the conductive material or the electromagnetic-wave absorbing material.

16. The positioning method as claimed in claim 11, wherein a first object is nonconductive, and the object storage device further comprises a plurality of shield elements, wherein when the first object is placed in the first storage vacancy, the first RFD tag is covered by a first shield element.

17. The positioning method as claimed in claim 11, wherein a first object RFID detecting the first object RFID tag to identify the first object by the RFID reader and the antenna.

18. The positioning method as claimed in claim 11, further comprising:
determining that a second RFID tag disposed in a second storage vacancy is no longer detectable b the RFID reader and the antenna; and
determining that the second storage vacancy is occupied according to the detection result of the RFID reader and according to the corresponding relationship between the RFID tags and the storage vacancies.

19. The positioning method as claimed in claim 11, wherein a second object RFID tag is affixed to a second object, and the positioning method further comprises:
detecting the second object RFID tag to identify the second object by the RFID reader and the antenna.
